(19) United States
(12) Patent Application Publication
(10) Pub. No.: US 2006/0035053 A1
(43) Pub. Date: Feb. 16, 2006

(54) Blanket, in particular quilt

(76) Inventors: Dieter Eichinger, Furstenfeld (AT); Friedrich Haussmann, Weyregg (AT); Peter Kruger, Kotzschau (DE); Norbert Kuhl, Ungenach (AT); Walter Six, Vocklabruck (AT)

Correspondence Address: BAKER & BOTTS, 30 ROCKEFELLER PLAZA, NEW YORK, NY, 10112, US

(21) Appl. No.: 11/080,332

(22) Filed: Mar. 15, 2005

Related U.S. Application Data
(63) Continuation of application No. PCT/AT03/00259, filed on Sep. 8, 2003.

(30) Foreign Application Priority Data
Sep. 16, 2002 (AT) A 1386/2002

(51) Int. Cl. B32B 1/04; D04H 13/00; D04H 1/46

(52) U.S. Cl. 428/74; 442/327; 442/402; 442/408

(57) ABSTRACT

A textile, in particular a blanket, preferably a quilt, comprises a bulky filling (2) embedded in a cover (1).

In order to make sure that such a textile exhibits a good thermal insulation, a high moisture transit and good recyclability at low costs, both the cover (1) and the filling (2) comprise Lyocell fibres, with the cover (1) being shaped as a fleece and the filling (2) being shaped as a high-loft fleece or as fibre balls or as Lyocell fibres introduced, as if blown, into the cover (1).

The invention relates to a textile, in particular a blanket, preferably a quilt, comprising a bulky filling embedded in a cover.

One of the main functions of a textile such as a blanket is its insulating effect. As in case of a pair of trousers, a jacket or a skiing parka for the winter season, the insulating effect should be sufficient in order to protect the body from cooling. Thereby, the actual insulator is the air. In the state of the art for protective clothing against cold and for blankets, filling materials such as down, wool and polyester provide a sufficiently large air cushion. A disadvantage of using such materials in the textile industry is that quilts as well as parkas are very thick and bulky. If the enclosed air cannot be immobilized to a sufficient degree, convection phenomena and thus a reduction in the insulating effect occur.

The human body controls its thermal balance by releasing water vapour. Especially at night, the body gives off no less than 0.41 of water vapour while a relatively low body temperature of about 85 W is produced. The release through a quilt or a jacket/pair of trousers etc. is that important, since otherwise an accumulation of water vapour might occur. In addition, the basic living conditions for microorganisms are created at high air humidities.

Thus, moisture storage and consequently moisture transport are of enormous significance for the assessment of a textile such as a blanket. According to the skin model (DIN EN 31092 (February 1994) or ISO 11092 (October 1993), respectively), those properties are characterized f.i. by the water-vapour transit index, the short-term water-vapour absorption capacity and the moisture balance index number.

Due to their high acquisition costs, quilts have a durability of about 5 to 10 years. Due to the release of moisture by the body, heat and substances contained in perspiration and in other liquid excretions, the growth of small organisms such as mites is favoured. In this way, allergies can be caused.

Therefore, washable quilts, which can be washed at 60° C., have so far been offered. That involves the disadvantage that most households are not provided with a washing machine having an adequate filling volume and that moreover the quilt loses in softness, bulk resilience, shape and suppleness when being washed. Furthermore, the effectiveness of washing for the purpose of mite control is disputed.

The invention aims at avoiding said drawbacks and difficulties and has as its object to produce a heat insulator as thin and lightweight as possible from filling fibres and cover materials, which exhibits a moisture absorption and moisture transport capacity as high as possible and which, due to its cost structure, may also be used as a disposable textile product or might possibly be used for only one season, i.e. for about one year. The strains of microorganisms developing over time, such as mites, fungi or bacteria, can be disposed together with the textile.

According to the invention, said object is achieved in that both the cover and the filling comprise Lyocell fibres, with the cover being shaped as a fleece and the filling being shaped as a high-loft fleece or as fibre balls or as Lyocell fibres loosely introduced, as if blown, into the cover.

Advantageous embodiments are characterized in the dependent claims.

The huge amounts of waste create an enormous environmental impact. At present, insulating textiles such as quilts etc. are mainly filled with polyester, down or wool or are wrapped into a fabric consisting either of 100% cotton, 100% polyester or mixtures thereof. Recycling those raw materials proves to be extremely difficult.

Due to the uniform raw material, the textile according to the invention is easily disposable. Since pure cellulose is involved, residue-free combustion is readily possible; furthermore, said product can be composted without problems. Disposal via the waste-paper line is conceivable as well.

Insulating textiles according to the introductory part of the specification have so far been produced mainly from woven and knitted fabrics, which are very expensive and sophisticated. In doing so, a yarn is woven or knitted from staple fibres into a fabric—for instance, by means of ring or rotor spinning methods—or by means of a filament yarn. Thereby, the colouring of the assembly may take place prior to or after spinning, knitting or weaving. In order to manufacture a piece of clothing or a textile assembly (f.i. of a quilt), composite structures from woven materials and nonwoven materials (f.i. a carded fleece) are used.

The use of nonwoven materials in the fields of clothing and household textiles is known. However, such articles have a disadvantage in that so far they have only been produced from synthetic fibres. A 100% cellulose fibre (f.i. from viscose) has so far been impossible, since viscose lacks in strength. Therefore, its use is limited.

Surprisingly, it has been found that Lyocell having an adequate fibre titre and manufactured by means of the spunlace technology yields textile fabrics that are very similar to those of woven textiles. They exhibit
high strength as well as
sufficient softness and guarantee
a large moisture transport.

Surprisingly, it also has been found that the masses per unit area of those nonwoven materials can be produced at up to 20 g/m², thereby falling by far short of those of traditional materials, i.e. of woven materials, for a comparable use (normally at from 90 to 100 g/m²). That means that, using a small amount of fibres, a textile can be produced at manageable costs. Extremely fine traditional fabrics can only be produced at very high expenses, i.e. by using the finest, most expensive yarns and weaving adjustments that lead to low productivity.

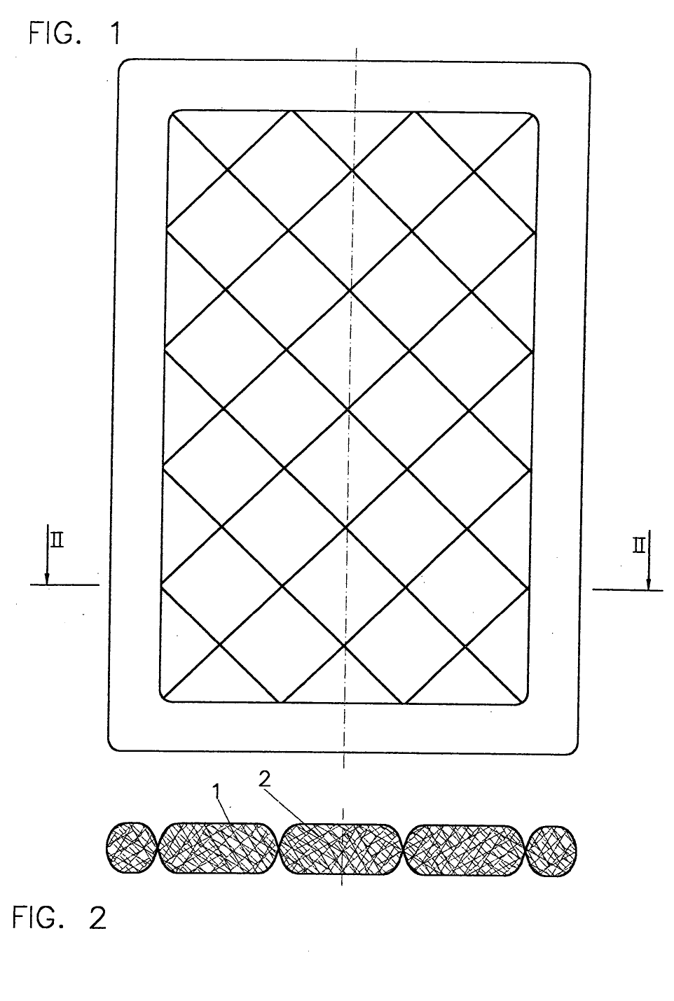

In the following, the invention is described in more detail by way of several exemplary embodiments. FIG. 1 of the drawing illustrates a view of a quilt, FIG. 2 illustrates a sectional view according to line II-II.

A quilt of the kind according to the invention is formed from Lyocell fibres. Cover 1 is a spunlace nonwoven fleece of f.i. 0.9 dtex with a mass per unit area of 40 g/m². Filling 2 is a high-bulk fleece made of Lyocell fibres of f.i. 6.7 dtex, which have been carded and combed. The length of the Lyocell fibres for the filling ranges from 40 to 70 mm, and for the cover it ranges from 30 to 40 mm. For the filling, also fibre balls made of the above-described Lyocell fibres might be used.

In the table below, various fillings in identical cotton covers are compared with each other in terms of their properties, wherein the physiological data were determined in accordance with the main model according to DIN EN 31092 (February 1994). The values are Rct-values.

TABLE I

| Sam- | | d | F | Rct | Rct/d |
|---|---|---|---|---|---|
| ple | Filling | mm | g/m² | 10³ m²k/W | 10³ (m²k/W)/mm |
| 1 | Lyocell 6.7 dtex | 30 | 550 | 757 | 25.2 |
| 3 | 50% Lyocell/50% | 25 | 286 | 575 | 23.0 |
| | polyester | | | | |
| 2 | wool | 35 | 466 | 754 | 21.5 |
| 5 | down | 75 | 468 | 1434 | 19.1 |
| 4 | polyester | 50 | 378 | 791 | 15.8 |

This table shows that Lyocell fibres of 6,7 dtex (sample 1), based on the thickness, yield the best insulating values and that polyester (sample 4) yields the poorest insulating values. By admixing polyester to the Lyocell (sample 3: 50%/50%), the insulating value deteriorates proportionally. 100% down (sample 5) and wool (sample 2) yield poorer results than a of such kind (sample 3).

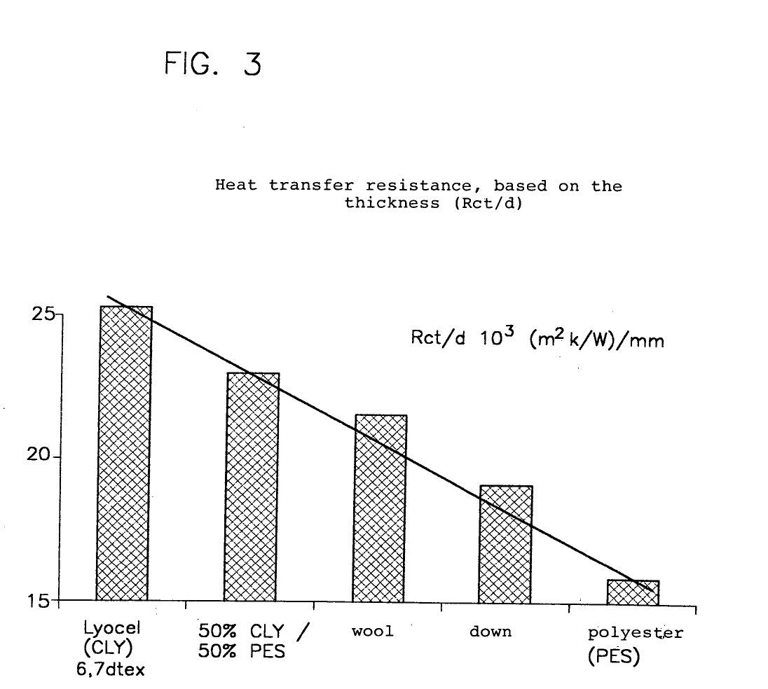

The insulating values according to Table I are represented in FIG. 3.

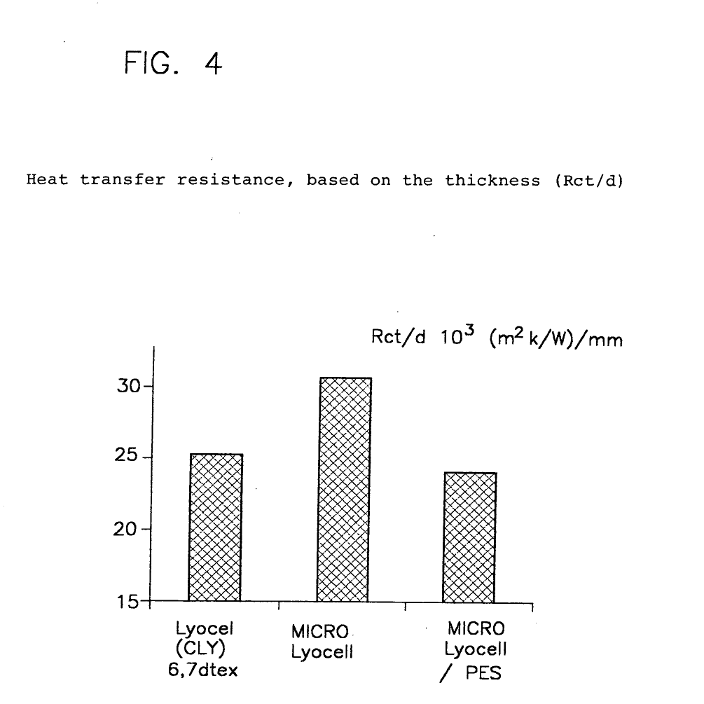

In Table II below, samples 1, 4 and 5 of Table I are compared with fillings formed from microfibres, i.e. from a Lyocell fibre having a titre of less than 1.0 dtex. The values of samples 1, 6 and 7 are represented in FIG. 4.

TABLE II

| Sam- | | d | F | Rct | Rct/d |
|---|---|---|---|---|---|
| ple | Filling | mm | g/m² | 10³ m²k/W | 10³ (m²k/W)/mm |
| 1 | Lyocell 6.7 dtex | 30 | 550 | 757 | 25.2 |
| 4 | polyester | 50 | 378 | 791 | 15.8 |
| 5 | 50% Lyocell/50% | 25 | 286 | 575 | 23.0 |
| | polyester | | | | |
| 6 | Lyocell MICRO | 15 | 204 | 457 | 30.5 |
| 7 | Lyocell MICRO/ | 30 | 278 | 725 | 24.2 |
| | polyester | | | | |

By using Lyocell microfibres, the already excellent insulating values can be improved even

In Table m below, quilts comprising different covers and fillings are compared, wherein, in each case, the quilt heights have been chosen such that the different quilts exhibit equal insulating values.

TABLE III

| | | Quilt |
|---|---|---|
| Cover | Filling | Height [mm] |
| cotton fabric | down | 75 |
| cotton fabric | 6.7 dtex Lyocell | 47 |
| nonwovens from 0.9 dtex | 6.7 dtex Lyocell | 33 |
| Lyocell 40 g/m² | | |
| nonwovens from 0.9 dtex | 0.9 dtex Lyocell | 28 |
| Lyocell 40 g/m² | | |

It can be seen that, while yielding the same insulating performance, the two quilts ranked last in the table are by far thinner than down with cotton fabrics or cotton fabrics with Lyocell fillings. The thinnest quilt is formed from Lyocell microfibres both for the cover and for the filling.

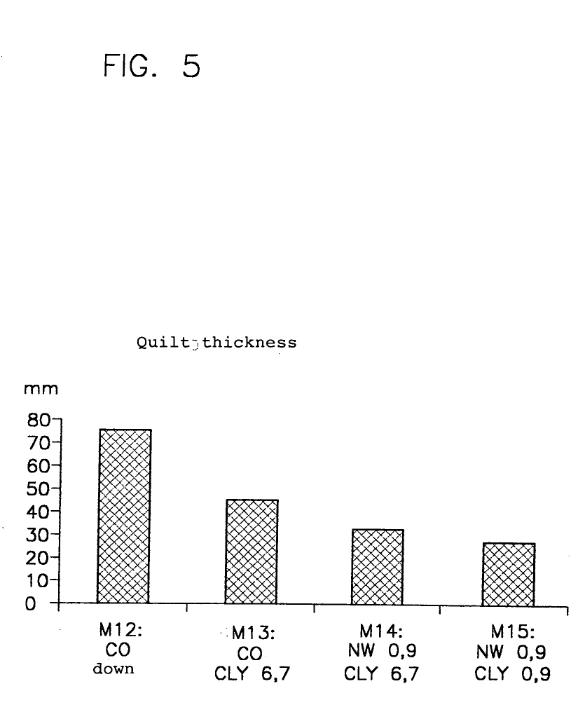

In FIG. 5, the quilt thicknesses of the quilts listed in Table III are represented graphically.

Table IV shows the water-vapour transit index for different quilts.

TABLE IV

| | | Water-Vapour Transit |
|---|---|---|
| Cover | Filling | Index [imt] |
| cotton fabric | 6.7 dtex Lyocell | 0.58 |
| sateen fabric Lyocell MICRO | 6.7 dtex Lyocell | 0.71 |
| nonwovens from 0.9 dtex | 6.7 dtex Lyocell | 0.79 |
| Lyocell 40 g/m² | | |
| nonwovens from 0.9 dtex | 0.9 dtex Lyocell | 0.87 |
| Lyocell 40 g/m² | | |

If good values for the water-vapour transit index are already achieved by using Lyocell as the filling fibre in the cotton cover, those values may be improved by 22% by using a Lyocell sateen fabric. With a Lyocell spunlace-nonwoven fleece, the value surprisingly increases by 36%, and with Lyocell Micro as the filling fibre, the maximum value, i.e. a 50% increase, is achieved.

Surprisingly, it has been shown that marvellous water-vapour transit index values can be achieved by using nonwoven covers.

The invention may be used for all textiles from which an insulating effect along with great moisture transport and lightness is demanded, such as for bed linens of all kinds, quilts, cushions, pillows, mattress coatings, as well as for clothings such as jackets and trousers, dungarees, parkas etc. The fillings may be formed from carded fleeces, but also from fibre balls made of Lyocell or mixtures thereof, or—as an inexpensive variant—also from Lyocell fibres loosely introduced, f.i. blown, into the cover. For special ranges of application, the Lyocell fibres for the filling may be mixed with down and/or polylactic acid fibres and/or cellulose acetate fibres and/or soybean fibres.

Furthermore, the cover may consist of a multilayer fleece for increasing its strength.

1-17. (canceled)

18. Textile for a blanket comprising a bulky filling embedded in a cover, wherein the cover and the filling comprise Lyocell fibers, wherein the cover is shaped as a fleece and the filling is shaped in a form selected from the group consisting of high-loft fleece, fiber balls and Lyocell fibers.

19. The textile according to claim 18, wherein the Lyocell fibers of the filling are blown into the cover.

20. The textile according to claim 18, wherein the Lyocell fibers of the cover exhibit a length of from 20 to 60 mm.

21. The textile according to claim 20, wherein the Lyocell fibers of the cover exhibit a length of from 30 to 40 mm.

22. The textile according to claim 18, wherein the Lyocell fibers of the filling exhibit a length of from 5 to 100 mm.

23. The textile according to claim 22, wherein the Lyocell fibers of the filling exhibit a length of from 20 to 70 mm.

24. The textile according to claim 18, wherein the Lyocell fibers of the cover exhibit a titer of from 0.1 to 1.7 dtex.

25. The textile according to claim 24, wherein the Lyocell fibers of the cover exhibit a titer of from 0.9 to 1.3 dtex.

26. The textile according to claim 18, wherein the Lyocell fibers of the filling exhibit a titre of from 0.7 to 8 dtex

27. The textile according to claim 26, wherein the Lyocell fibers of the filling exhibit a titre of from 0.9 to 7 dtex.

28. The textile according to claim 18, wherein the cover exhibits a mass per unit area of from 20 to 120 g/m .

29. The textile according to claim 28, wherein the cover exhibits a mass per unit area of from 30 to 50 g/m².

30. The textile according to claim 18, having a thickness of up to 100 mm, wherein the filling exhibits a compressed state.

31. The textile according to claim 30, having a thickness of from 5 to 40 mm.

32. The textile according to claim 18, wherein the Lyocell fibers of the cover are parallelized and billowed.

33. The textile according to claim 32, wherein the Lyocell fibers of the cover are carded.

34. The textile according to claim 18, wherein the Lyocell fibers of the cover are water-jet solidified or needled.

35. The textile according to claim 18, wherein the Lyocell fibers of the cover are solidified chemically or thermally.

36. The textile according to claim 18, wherein the Lyocell fibers of the filling are carded and combed.

37. The textile according to claim 18, wherein the Lyocell fibers of the filling are solidified chemically or thermally.

38. The textile according to claim 18, wherein the filling further comprises one or more items selected from the group consisting of down, polylactic acid fibers, cellulose acetate fibers and soybean fibers.

39. The textile according to claim 38, wherein at least 50% of the weight of the filling is produced by Lyocell fibers.

40. The textile according to claim 18, wherein the cover comprises mixture of Lyocell fibers and one or more items selected from the group consisting of polylactic acid fibers, cellulose acetate fibers and soybean fibers.

41. The textile according to claim 40, wherein the cover is formed from at least 50% Lyocell fibers by weight.

42. The textile according to claim 18, further comprising a hard-wearing cover.

43. The textile acording to claim 18, wherein the blanket is a quilt.
